(19) United States
(12) Patent Application Publication
(10) Pub. No.: US 2026/0155960 A1
(43) Pub. Date: Jun. 4, 2026

(54) SYSTEMS AND METHODS FOR REMOTE QUANTUM KEY DISTRIBUTION

(71) Applicant: JPMORGAN CHASE BANK, N.A., New York, NY (US)

(72) Inventors: Wenyu KON, Singapore (SG); Ignatius William PRIMAATMAJA, Singapore (SG); Kaushik CHAKRABORTY, Singapore (SG); Lim Ci WEN, Singapore (SG); Marco PISTOIA, Amawalk, NY (US)

(21) Appl. No.: 18/947,991

(22) Filed: Nov. 14, 2024

(51) Int. Cl. H04L 9/08

(52) U.S. Cl. CPC H04L 9/0852; H04L 9/0877

(57) ABSTRACT

A first party quantum trusted executed environment (QTEE) receives a first party initial key from a first party and generates an expanded key; a second party QTEE receives a second party initial key from a second party and generates an expanded key; an untrusted third party controls an untrusted quantum source to distribute an input quantum system to the QTEEs; the first party QTEE encodes the input quantum system into a first quantum system and sends the first quantum system to the untrusted third party; the second party QTEE encodes the input quantum system into a second quantum system and sends the second quantum system to the untrusted third party; the untrusted third party performs an entangling measurement on the quantum systems resulting an entangling measurement outcome and sends to the parties; and the parties generate secret keys using the expanded keys and the entangling measurement outcome.

### BACKGROUND OF THE INVENTION

### 1. Field of the Invention

Embodiments relate to systems and methods for remote quantum key distribution.

### 2. Description of the Related Art

Quantum key distribution (QKD) is a nascent technology that allows two distant parties to share a common secret key. Its distinctive feature is the promise of information-theoretic security: the security of QKD does not depend on any computational assumptions, which makes it quantum-safe (i.e., secure against attacks that rely on quantum computers). Early migration to QKD would protect organizations from the harvest now, decrypt later attacks, where malicious attackers store encrypted confidential data now and decrypt them later when large scale quantum computers become available.

While QKD has a huge potential in terms of security, there are some weaknesses in its commercial and practical implementations. Amongst these weaknesses, three main issues faced by commercial and practical systems are:
(a) limited range: The signal loss in an optical fiber scales exponentially with the length of the fiber. Unlike in classical communications, the quantum signals used in QKD cannot be amplified. As quantum repeater technology is still in its infancy, the range of typical fiber-based QKD is limited to maximally hundreds of kilometers;
(b) issues with scalability: QKD is a point-to-point communication protocol that requires the communicating parties to be connected via a quantum channel. If there are n users in a network, and each user wants a direct link to the others, the number of links (e.g., the optical fiber connections) that have to be established is n(n−1)/2;
(c) side-channel attacks: To analyze the security of a QKD protocol, the devices that implement the QKD protocol are modeled. The models often only hold in idealized scenario (e.g., when the devices are not tampered with), and a sophisticated adversary can exploit the gap between the security proven in theory and the actual hardware implementation. Thus, the actual security of a QKD protocol is often more limited than the one suggested by the theoretical security proof.

### SUMMARY OF THE INVENTION

Systems and methods for remote quantum key distribution are disclosed. In one embodiment, a method may include: receiving, by a first party quantum trusted executed environment (QTEE) and from a first party computer program, a first party initial key; generating, by the first party QTEE, a first party expanded key using the first party initial key; receiving, by a second party QTEE and from a second party computer program, a second party initial key; generating, by the second party QTEE, a second party expanded key using the second party initial key; controlling, by an untrusted third party computer program executed by a server, an untrusted quantum source to distribute an input quantum system to the first party QTEE and to the second party QTEE; encoding, by the first party QTEE, the input quantum system into a first encoded quantum system using the first party expanded key; sending, by the first party QTEE, the first encoded quantum system to the untrusted third party computer program; encoding, by the second party QTEE, the input quantum system into a second encoded quantum system using the second party expanded key; sending, by the second party QTEE, the second encoded quantum system to the untrusted third party computer program; performing, by the untrusted third party computer program and using an untrusted quantum measurement device, an entangling measurement on the first encoded quantum system and the second encoded quantum system, resulting an entangling measurement outcome; sending, by the untrusted third party, the entangling measurement outcome to the first party computer program and the second party computer program, wherein the first party computer program may be configured to generate a first party secret key using the first party expanded key and the entangling measurement outcome and the second party computer program may be configured to generate a second party secret key using the second party expanded key and the entangling measurement outcome.

In one embodiment, the method may further include: sharing, by the first party computer program, a first pseudo-random number generator algorithm with the first QTEE, wherein the first party QTEE generates the first party expanded key using the first party initial key as a seed to the first pseudo-random number generator algorithm; and sharing, by the second party computer program, a second pseudo-random number generator algorithm with the second party QTEE, wherein the second party QTEE generates the second party expanded key using the second party initial key as a seed to the second pseudo-random number generator algorithm.

In one embodiment, the entangling measurement may include a Bell state measurement.

In one embodiment, the untrusted quantum source distributes a first quantum system to the first party QTEE, and a second quantum system to the second party QTEE, wherein the first quantum system and the second quantum system are not the same.

In one embodiment, the method may further include: communicating, by the first party computer program, using the first party secret key; and communicating, by the second party computer program, using the second party secret key.

According to another embodiment, a system may include: a first party electronic device executing a first party computer program; a second party electronic device executing a second party computer program; a server executing an untrusted third party computer program, and comprising: a first party quantum trusted execution environment (QTEE); a second party QTEE; an untrusted quantum source; and an untrusted quantum measurement device. The first party computer program communicates or transmits a first party initial key with the first party QTEE; the first party QTEE generates a first party expanded key using the first party initial key; the second party electronic device communicates or transmits a second party initial key with a second party QTEE; the second party QTEE generates a second party expanded key using the second party initial key; the untrusted third party computer program controls the untrusted quantum source to distribute an input quantum system to the first party QTEE and to the second party QTEE; the first party QTEE encodes the input quantum system into a first encoded quantum system using the first party expanded key; the first party QTEE sends the first encoded quantum system to the untrusted third party computer program; the second party QTEE encodes the input quantum system into a second encoded quantum system using the second party expanded key; the second party QTEE sends the second encoded quantum system to the untrusted third party computer program; the untrusted third party computer program performs, using the untrusted quantum measurement device, an entangling measurement on the first encoded quantum system and the second encoded quantum system, resulting an entangling measurement outcome; the untrusted third party sends the entangling measurement outcome to the first party electronic device and the second party electronic device; the first party electronic device generates a first party secret key using the first party expanded key and the entangling measurement outcome; and the second party electronic device generates a second party secret key using the second party expanded key and the entangling measurement outcome.

In one embodiment, the first party electronic device communicates or transmits a first pseudo-random number generator algorithm with the first QTEE, and the first party QTEE generates the first party expanded key using the first party initial key as a seed to the first pseudo-random number generator algorithm; and the second party electronic device share a second pseudo-random number generator algorithm with the second party QTEE, and the second party QTEE generates the second party expanded key using the second party initial key as a seed to the second pseudo-random number generator algorithm.

In one embodiment, the entangling measurement may include a Bell state measurement.

In one embodiment, the untrusted quantum source distributes a first quantum system to the first party QTEE, and a second quantum system to the second party QTEE, wherein the first quantum system and the second quantum system are not the same.

In one embodiment, the untrusted quantum source may include a laser, a single-photon source, an entangled-photon source, or light-emitting diodes (LEDs).

In one embodiment, the first QTEE and/or the second QTEE comprise an input/output port, a Faraday mirror, a quantum encoder, an attenuator, an optical power limiter, and a filter.

In one embodiment, the first QTEE and/or the second QTEE comprise an input/output port, a Faraday mirror, a quantum encoder, an attenuator, a biased beam splitter, a monitoring detector, and a filter.

In one embodiment, the first QTEE and/or the second QTEE comprise an input port, a first optical power limiter, a first attenuator, a quantum encoder, a second attenuator, a second optical power limiter, a filter, and an output port.

According to another embodiment, a method may include: communicating or transmitting, by a second party computer program, an initial key with a trusted server; generating, by the trusted server, an expanded key using the initial key; encoding, by the trusted server, quantum states from a trusted quantum source into an encoded quantum system using the expanded key; sending, by the trusted server, the encoded quantum system to a first party computer program; performing, by the first party computer program and using a quantum device, a quantum measurement on the encoded quantum system; and performing, by the first party computer program and the second party computer program, classical post-processing over an authenticated classical channel using the quantum measurement.

In one embodiment, the expanded key may be generated using a pseudo-random number generator with the initial key as a seed.

In one embodiment, the quantum systems may be determined by the expanded key.

In one embodiment, the quantum measurement may be a quantum measurement from the BB84 protocol.

In one embodiment, the quantum measurement may include a bit-string that may be weakly correlated to the expanded key.

In one embodiment, the classical post-processing may convert the outcome of the quantum measurement and the expanded key into a pair of secret keys.

In one embodiment, the pair of secret keys may be identical.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for remote quantum key distribution using untrusted quantum measurement according to an embodiment;

FIG. 2 illustrates a method for remote quantum key distribution using untrusted quantum measurement according to an embodiment;

FIG. 3 illustrates a system for remote prepare and measure quantum key distribution according to an embodiment;

FIG. 4 illustrates a method for remote prepare and measure quantum key distribution according to an embodiment;

FIG. 5 illustrates a system for remote measurement device independent quantum key distribution according to an embodiment;

FIG. 6 illustrates a method for remote measurement device independent quantum key distribution according to an embodiment;

FIGS. 7A-7D illustrate exemplary implementation of quantum trusted execution environments according to embodiments; and

FIG. 8 depicts an exemplary computing system for implementing aspects of the present disclosure.

### DETAILED DESCRIPTION OF PREFERRED EMBODIMENTS

Embodiments relate to systems and methods for remote quantum key distribution.

Embodiments provide a network of users with a quantum trusted execution environment (“QTEE”), which is a secure location inside a server, where quantum operations can be trusted. The users can share an initial pre-shared key with the QTEE either by using standard QKD, or via a secure channel (e.g., by physically delivering the key to the QTEE).

For example, if there are two users that wish to share a secret key, the users can use their respective QTEEs to perform a measurement device-independent QKD (“MDI-QKD”) protocol with the help of an untrusted service provider inside the server. To perform the MDI-QKD protocol, the untrusted service provider sends each QTEE some laser pulses. Each QTEE will then encode a quantum state into these laser pulses based on the initial pre-shared key, and may send it back to the service provider for entangling measurement. The service provider then announces the results of the entangling measurement to the users, and the users can perform classical post-processing to their respective data, taking into account the service provider's announcements, to obtain a pair of identical and secret keys.

Embodiments may provide at least some of the following technical advantages. First, because the quantum communications are performed inside the server, there is no limitation on the range of communication of the users since they only need to communicate classically with the server and with each other. This is in contrast to typical QKD protocols where the range is typically limited.

Next, because the MDI-QKD protocol is secure against any imperfections and side-channel attacks in the measurement device. Furthermore, since the laser pulses sent by the service provider are treated as an untrusted light source, the protocol is also secure against most source side-channel attacks. This is in contrast to most QKD protocols where both the source and measurement device are susceptible to side-channel attacks and ad-hoc countermeasures are necessary.

Next, the solution is highly scalable as each user only needs to be connected to the respective QTEE, which in turn only needs a quantum channel connected to the untrusted service provider. This is in contrast to the standard QKD network where the number of quantum channels scale quadratically.

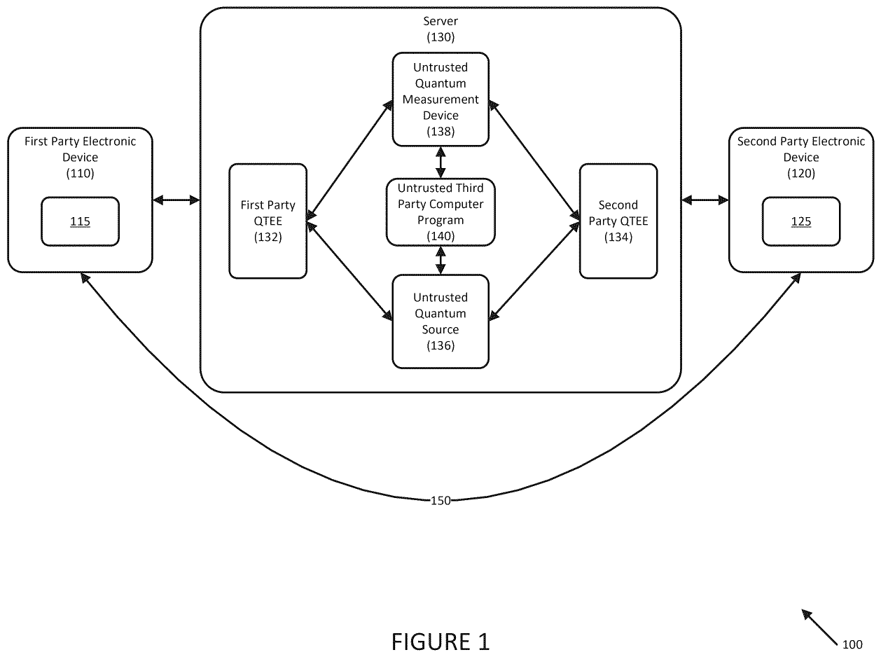

Referring to FIG. 1, a system for remote quantum key distribution is disclosed according to an embodiment. System 100 may include first party electronic device 110 and second party electronic device 120, which may be a classical (e.g., microprocessor-based) electronic device. Examples of classical electronic devices include servers (e.g., physical and/or cloud-based), computers (e.g., workstations, desktops, laptops, notebooks, tablets, etc.), smart devices (e.g., smart phones), Internet of Things (IoT) appliances, etc.

First party electronic device 110 and second party electronic device 120 may execute first party computer program 115 and second party computer program 125, respectively. First party electronic device 110 and second party electronic device 120 may also communicate over authenticated classical communication channel 150.

System 100 may further include server 130, which may be associated with an untrusted third party. Server 130 may execute untrusted third party computer program 140, and may include first party QTEE 132, second party QTEE 134, untrusted quantum source 136, and untrusted quantum measurement device 138. First party QTEE 132 may interface with first party computer program 115 using a classical communication channel, and second party QTEE 134 may interface with second party computer program 125 using a classical communication channel. First party QTEE 132 and second party QTEE 134 may interface with untrusted quantum source 136 and untrusted quantum measurement device 138 using quantum-supported communication channels, such as optical fibers.

Untrusted quantum source 136 may be a source of quantum systems, such as a laser, a single-photon source, an entangled-photon source, light-emitting diodes (LED), etc.

Untrusted quantum measurement device 138 may measure quantum systems from first party QTEE 132 and second party QTEE 138.

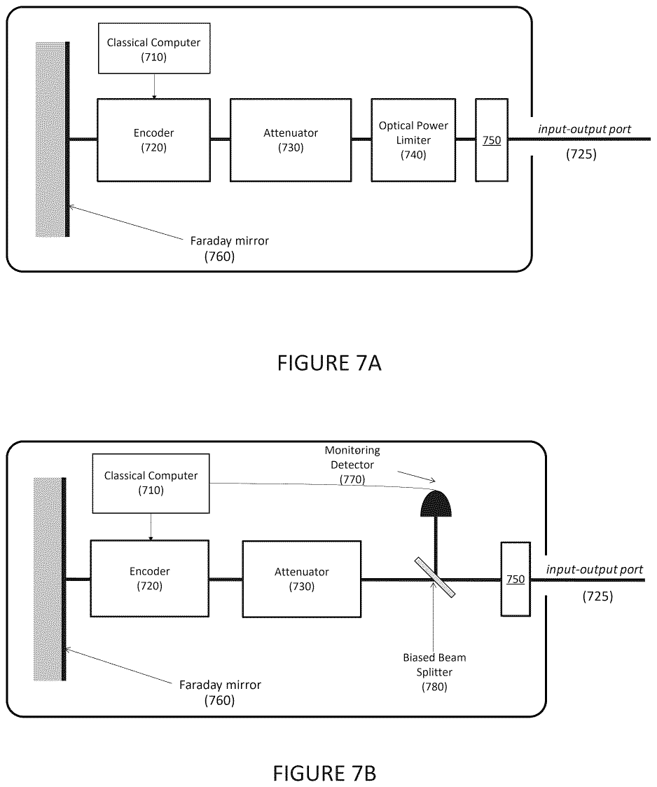

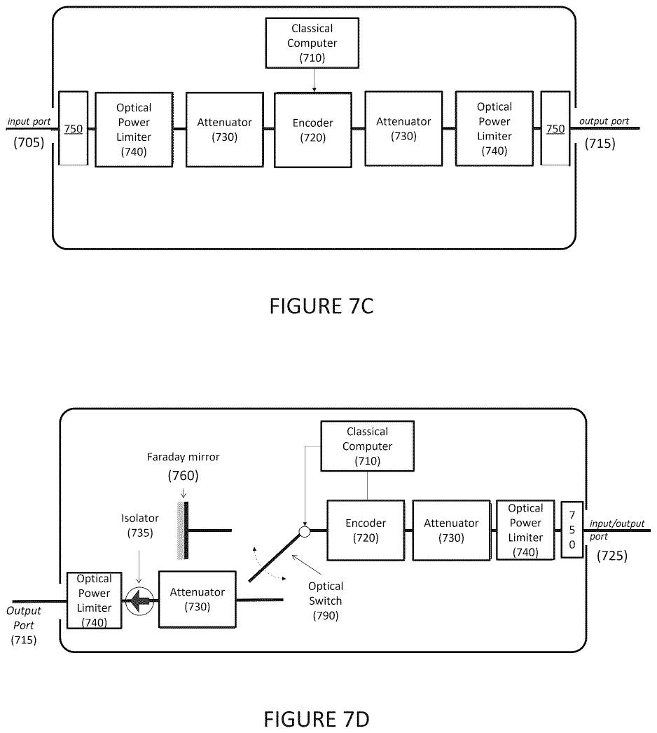

Referring to FIGS. 7A-7D, exemplary implementations of quantum trusted execution environments are provided according to embodiments. FIG. 7A depicts a QTEE with a passive power limiter. FIG. 7B depicts a QTEE with an active power limiter. FIG. 7C depicts a passive QTEE with two ports. FIG. 7D depicts a passive QTEE with two ports and a switch.

First party QTEE 132 and second party QTEE 138 may receive quantum systems at input port 705 and may output quantum systems at output port 715. In embodiments, a single input-output port 725 may be provided.

Depending on the implementation, first party QTEE 132 and second party QTEE 138 may include classical computer 710, quantum encoder 720 (e.g., an optical modulator), attenuator 730, isolator 735, optical power limiter 740, filter 750, Faraday mirror 760, monitoring detector 770, bias beam splitter 780, and optical switch 790.

Classical computer 710 may include a classical processor (not shown), a classical memory (not shown) to store an initial key, a pseudo-random number generator (not shown) to expand the initial key, an interface to control quantum encoder 720, and a computer program (not shown) to specify the commands.

In active power limiter embodiments, classical computer 710 may receive some electrical signals from monitoring detector 770, and may communicate with the respective party to announce that the protocol needs to be aborted when the input power exceeds the pre-determined threshold.

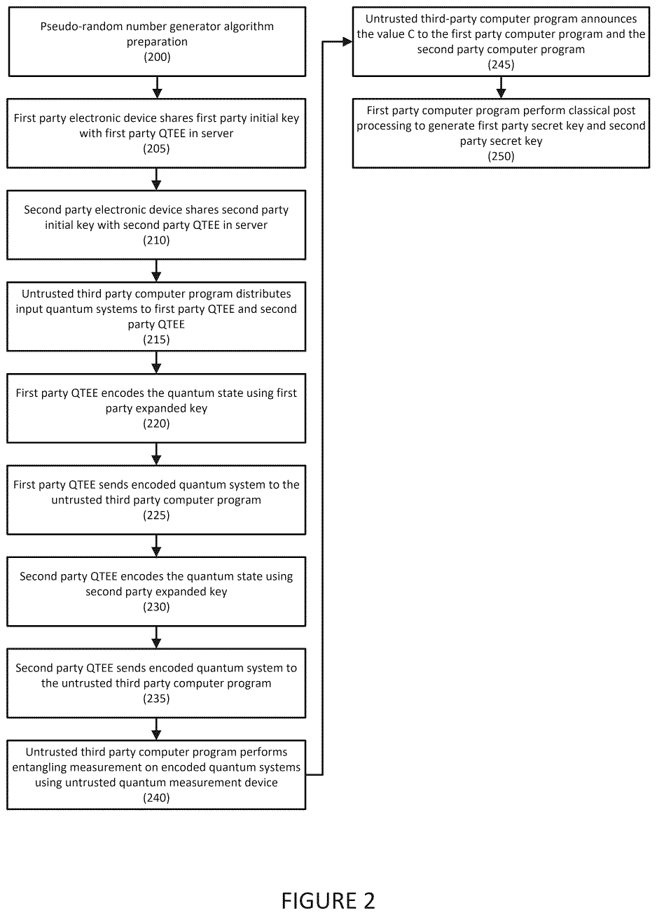

Referring to FIG. 2, a method for remote quantum key distribution is disclosed according to an embodiment. A first party computer program executed by the first party electronic device, and a second party computer program executed by the second party electronic device, may perform the protocol.

In step 200, a first party computer program and a first party QTEE may share a first pseudo-random number generator algorithm, and a second party computer program and a second party QTEE may share a second pseudo-random number generator algorithm. The first pseudo-random number generator algorithm and the second pseudo-random number generator algorithm may be deterministic algorithms that take a short bit-string, or a seed, as an input and gives a longer bit-string that looks random.

In step 205, the first party computer program may communicate or transmit a first party initial key, R_{A}, with the first party QTEE in a server. The first party initial key R_{A} may be communicated or transmitted using a standard QKD method between the first party QTEE and the first party computer program, by using key distribution methods that rely on hardware assumptions (e.g., a Hardware Secure Module, or HSM) or by physically delivering the key to the first party QTEE.

The first party initial key R_{A} and the second party initial key R_{B} may be a pair of identical bit strings shared between the first party and the first party QTEE, and the second party and the second party QTEE, respectively.

This can be generated by using a random number generator.

The first party QTEE may receive the first party initial key, R_{A} and may use it as a seed to a first party pseudo-random number generator. Using the first pseudo-random number generator algorithm, the first party pseudo-random number generator may generate a first party expanded key X_{A}.

In step 210, a second party computer program may communicate or transmit a second party initial key, R_{B}, with a second party QTEE in a server. This may be similar to step 205, above.

The second party QTEE may receive the second party initial key, R_{B} and may use it as a seed to a second party pseudo-random number generator. Using the second pseudo-random number generator algorithm, the second party pseudo-random number generator may generate a second party expanded key X_{B}.

In step 215, an untrusted third party computer program may control an untrusted quantum source to distribute input quantum systems to the first party QTEE and the second party QTEE. The input quantum systems distributed to the first party QTEE and the second party QTEE may not be the same (e.g., they could be laser pulses with different intensities).

In one embodiment, the untrusted third party computer program may synchronize the untrusted quantum source with the first and second QTEEs such that each respective QTEE applies the encoding when the quantum system arrives at the QTEE.

In step 220, the first party QTEE may receive the input quantum system from the untrusted quantum source and may encode the quantum system using the first party expanded key X_{A}.

In general, the first party expanded key X_{A} includes the bit value and the basis for encoding. The way in which this information is encoded into the quantum system depends on the specific encoding scheme. For example, when using the polarization encoding scheme of the BB84 protocol, the encoding may be given by: bit value 0 and basis 0: horizontal polarization; bit value 1 and basis 0: vertical polarization; bit value 0 and basis 1: diagonal polarization; bit value 1 and basis 1: anti-diagonal polarization.

In step 225, the first party QTEE may send the encoded quantum system, ρ^{X}^{_{A}}, to the untrusted third party computer program.

In step 230, the second party QTEE may receive the input quantum system from the untrusted quantum source and may encode the quantum system using the second party expanded key X_{B}.

In step 235, the second party QTEE may send the encoded quantum system, ρ^{X}^{_{B}}, to the untrusted third party computer program.

In step 240, the untrusted third party computer program performs entangling measurement on the two encoded quantum systems using an untrusted quantum measurement device. The output of the entangling measurement is an entangling measurement outcome, C.

The entangling measurement may be based on the encoding performed in steps 225 and 235. For example, when polarization encoding is used, the appropriate entangling measurement, such as a Bell state measurement, may be performed by interfering with the quantum systems on a balanced beam-splitter. A polarization measurement on each output port of the balanced beam-splitter (this is a device that splits a light pulse into two light pulses with equal intensities) may then be performed. For other types of encoding, other measurements may be used.

For each output port, the polarization measurement can be done by using a polarizing beam-splitter (this is a device that fully transmits light with a given polarization (say, horizontal) and fully reflects light which is polarized in the perpendicular polarization (i.e., vertical in this example) and two single-photon detectors, one in each output port of the polarizing beam-splitter.

If phase encoding is used, the entangling measurement corresponds to interfering the two light pulses on a balanced beam-splitter and putting a single-photon detector in each output port.

In step 245, the untrusted third-party computer program may announce, transmit, or send the entangling measurement outcome C to the first party computer program and the second party computer program over classical communication channels.

In step 250, the first party computer program may perform classical post-processing to generate a first party secret key K_{A}, from the first party expanded key X_{A} and the entangling measurement outcome C, and the second party computer program may generate a second party secret key K_{B} from the second party expanded key X_{B} and the entangling measurement outcome C.

The classical post-processing that is performed may depend on the specific protocol that is being used. In general, classical post-processing may include three steps: (1) sifting, where the first and second parties discard data that are uncorrelated, (2) information reconciliation (also called error correction and error verification), where the first and second parties exchange classical information so that they can obtain keys that are identical (i.e., correcting any discrepancies in their keys), then they compare hashes of their respective keys to check if their keys are indeed identical, (3) privacy amplification, where they apply random hashing onto their respective keys so that the output of the hash (which is now shorter) is completely random and uncorrelated to any potential adversary.

The first party computer program and the second party computer program may then use the first party secret key and the second party secret key, respectively, to communicate.

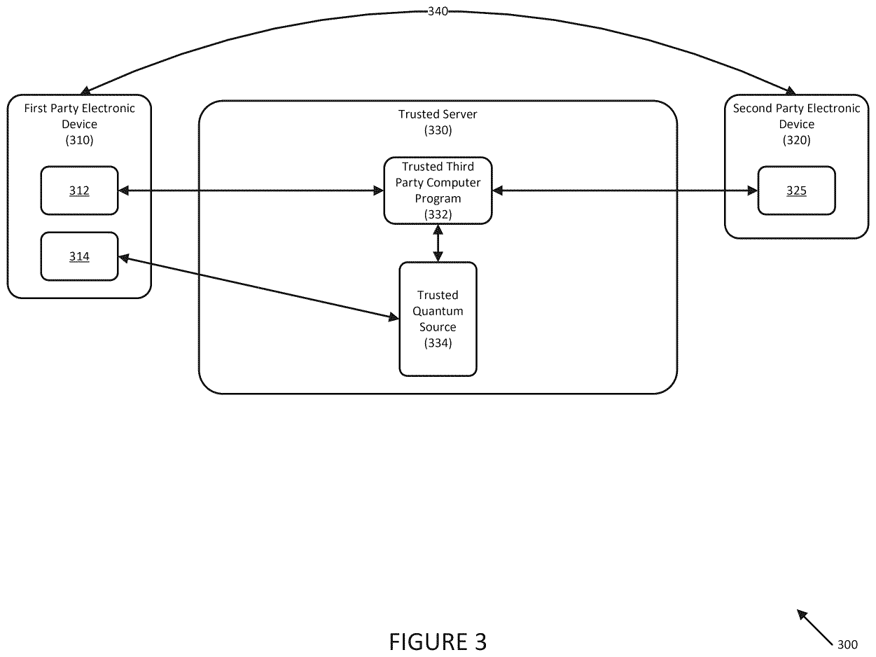

Referring to FIG. 3, a system for remote prepare and measure quantum key distribution is disclosed according to an embodiment. System 300 may include first party electronic device 310 and second party electronic device 320. First party electronic device 310 and second party electronic device 320 may communicate over authenticated classical channel 340.

In one embodiment, the communication over authenticated classical channel 340 may take place after the quantum communication (i.e., trusted server 330 sending quantum systems to first party electronic device 310, and first party electronic device 310 measuring these quantum systems) between trusted server 330 and first party electronic device 310. In one embodiment, communication over authenticated classical channel 340 may be part of the key exchange protocol that is used.

First party electronic device 310 and second party electronic device 320 may execute first party computer program 312 and second party computer program 325, respectively.

First party electronic device 310 may also include first party quantum measuring device that may measure quantum systems communicated by trusted quantum source 334. First party quantum measuring device and trusted quantum source 334 may communicate using a communication channel that supports quantum communication.

System 300 may further include trusted server 330, which may execute trusted third party computer program 332 and trusted quantum source 334.

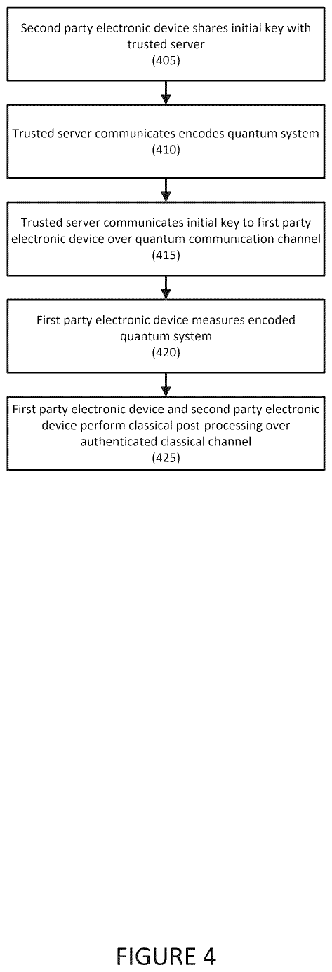

Referring to FIG. 4, a method for remote prepare and measure quantum key distribution is disclosed according to an embodiment.

In step 405, a second party electronic device may communicate or transmit an initial key with a trusted server. In one embodiment, the initial key sharing may be done using standard QKD, key distribution methods based on hardware assumptions, or by physically delivering the initial key to the trusted server.

In step 410, the trusted server may encode a quantum system. For example, the trusted server may use a pseudo-random number generator to expand the initial key to a longer bit-string, expanded key X_{A}. The trusted server may then use a trusted quantum source to encode quantum states into some quantum systems, where the quantum states are determined by the expanded key X_{A}.

In step 415, the trusted server may communicate the encoded quantum systems to the first party electronic device over a quantum communication channel.

In step 420, the first party electronic device may perform quantum measurement on the encoded quantum systems. The exact quantum measurement being performed by the first party may depend on the protocol and the encoding scheme. For example, if the BB84 protocol is used with the polarization encoding, a possible quantum measurement is one with a balanced beam-splitter (to choose the measurement basis), then polarization measurement on each output port of the balanced beam-splitter.

The output of the quantum measurement may be a bit-string that is weakly correlated to the first party expanded key X_{A}. This means that the bit string will not be perfectly secret and also not perfectly identical to the first party expanded key X_{A}.

In step 425, the first party electronic device and the second party electronic device may perform classical post-processing over an authenticated classical channel. The authenticated classical channel may be any suitable classical communication channel (e.g., an optical fiber, a radio, over the internet, etc.). The channel may be authenticated using public key cryptography, by pre-sharing an initial key beforehand, etc.

The classical post-processing may convert the quantum measurement into a pair of secret keys, wherein the secret keys comprise bit-strings that are identical and secret. The secret keys are known only to the parties and their QTEEs.

The classical post-processing that is performed may depend on the specific protocol that is being used. In general, classical post-processing may include three steps: (1) sifting, where the first and second parties discard data that are uncorrelated, (2) information reconciliation (also called error correction and error verification), where the first and second parties exchange classical information so that they can obtain keys that are identical (i.e., correcting any discrepancies in their keys), then they compare hashes of their respective keys to check if their keys are indeed identical, (3) privacy amplification, where they apply random hashing onto their respective keys so that the output of the hash (which is now shorter) is completely random and uncorrelated to any potential adversary.

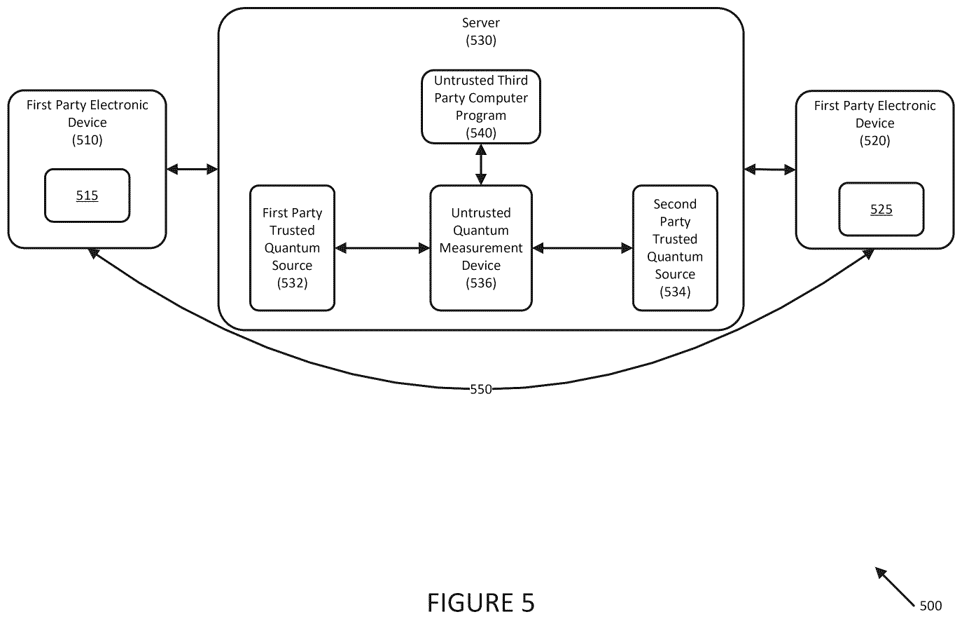

Referring to FIG. 5, a system for remote measurement device independent quantum key distribution is disclosed according to an embodiment. System 500 may include first party electronic device 510 and second party electronic device 520, which may be a classical (e.g., microprocessor-based) electronic device. Examples of classical electronic devices include servers (e.g., physical and/or cloud-based), computers (e.g., workstations, desktops, laptops, notebooks, tablets, etc.), smart devices (e.g., smart phones), Internet of Things (IoT) appliances, etc.

First party electronic device 510 and second party electronic device 520 may execute first party computer program 515 and second party computer program 525, respectively. First party electronic device 510 and second party electronic device 520 may also communicate over authenticated classical communication channel 550.

System 500 may further include server 530, which may be associated with an untrusted third party. Server 530 may execute untrusted third party computer program 540, and may include first party trusted quantum source 532, second party trusted quantum source 534, and untrusted quantum measurement device 536. First party trusted quantum source 532 may interface with first party computer program 515 using a classical communication channel, and second party trusted quantum source 534 may interface with second party computer program 525 using a classical communication channel. First party trusted quantum source 532 and second party trusted quantum source 534 may interface with untrusted quantum measurement device 536 using quantum-supported communication channels, such as optical fibers.

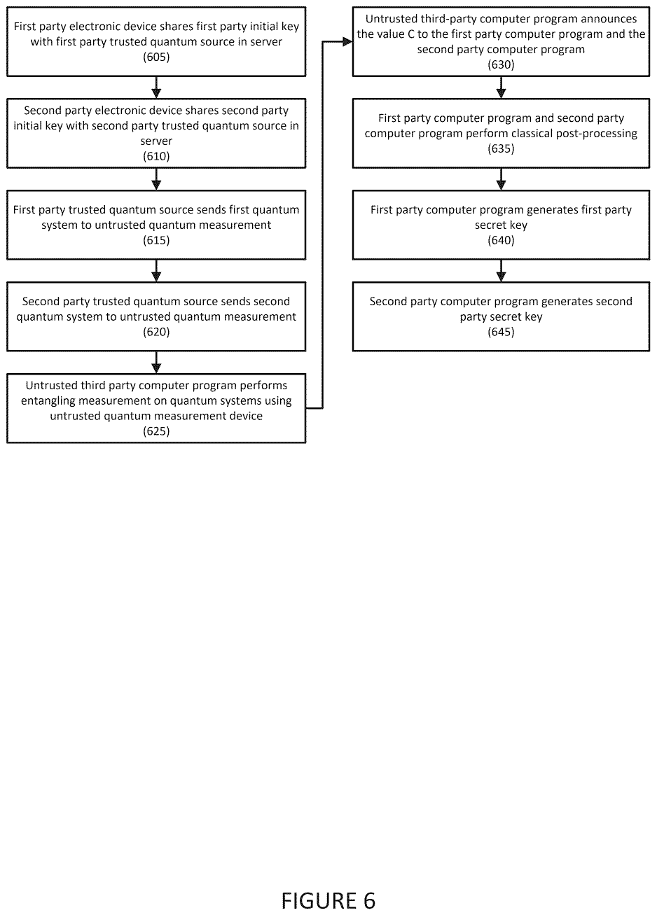

Referring to FIG. 6, a method for remote measurement device independent quantum key distribution is disclosed according to an embodiment.

In step 605, a first party electronic device may communicate or transmit a first party initial key, R_{A}, with a first party trusted quantum source in a server.

In step 610, a second party electronic device may communicate or transmit a second party initial key, R_{B}, with a second party trusted quantum source in a server.

In step 615, the first party trusted quantum source may send an encoded quantum system, ρ^{X}^{_{A}}, to the untrusted third party computer program.

In step 620, the second party trusted quantum source may send an encoded quantum system, ρ^{X}^{_{B}}, to the untrusted third party computer program.

In step 625, the untrusted third party computer program may perform an entangling measurement on the two quantum systems using the untrusted quantum measurement device. The output of the entangling measurement is an entangling measurement outcome, C.

The entangling measurement may be based on the encoding performed in steps 615 and 620. For example, when polarization encoding is used, the appropriate entangling measurement (called Bell state measurement) may be performed by interfering with the quantum systems on a balanced beam-splitter. A polarization measurement on each output port of the balanced beam-splitter (this is a device that splits a light pulse into two light pulses with equal intensities) may then be performed.

For each output port, the polarization measurement can be done by using a polarizing beam-splitter, such as a device that fully transmits light with a given polarization (say, horizontal) and fully reflects light which is polarized in the perpendicular polarization (i.e., vertical in this example) and two single-photon detectors, one in each output port of the polarizing beam-splitter.

If phase encoding is used, the entangling measurement corresponds to interfering the two light pulses on a balanced beam-splitter and putting a single-photon detector in each output port.

In step 630, the untrusted third-party computer program may announce the entangling measurement outcome C to the first party computer program and the second party computer program over classical communication channels.

In step 635, the first party computer program and the second party computer program may perform classical post-processing for the first party computer program to obtain a first party secret key K_{A}, from the first party expanded key X_{A} and C, and for the second party computer program to obtain a second party secret key K_{B} from second party expanded key X_{B} and C.

The classical post-processing that is performed may depend on the specific protocol that is being used. In general, classical post-processing may include three steps: (1) sifting, where the first and second parties discard data that are uncorrelated, (2) information reconciliation (also called error correction and error verification), where the first and second parties exchange classical information so that they can obtain keys that are identical (i.e., correcting any discrepancies in their keys), then they compare hashes of their respective keys to check if their keys are indeed identical, (3) privacy amplification, where they apply random hashing onto their respective keys so that the output of the hash (which is now shorter) is completely random and uncorrelated to any potential adversary.

In Step 640, the first party computer program may use the value of the party expanded key X_{A} and the entangling measurement outcome C to generate the first party secret key K_{A}.

In Step 645, the second party computer program may use value the second party expanded key X_{B} and the entangling measurement outcome C to generate the second party secret key K_{B}.

Examples of systems and methods for quantum key distribution are disclosed in U.S. patent application Ser. No. 18/174,768 and U.S. patent application Ser. No. 18/305,039, the disclosure of which are hereby incorporated, by reference, in their entireties.

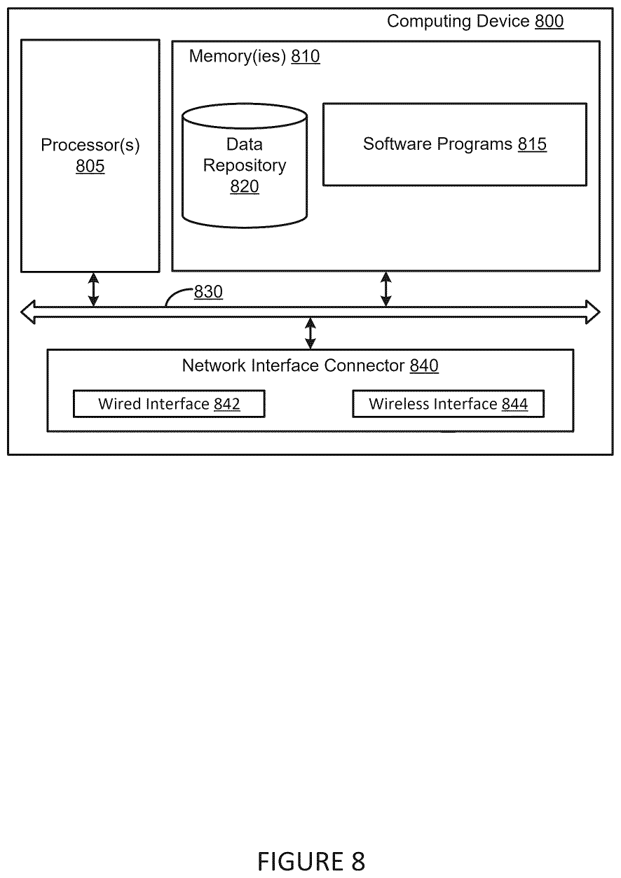

FIG. 8 depicts an exemplary computing system for implementing aspects of the present disclosure. FIG. 8 depicts exemplary computing device 800. Computing device 800 may represent the system components described herein. Computing device 800 may include processor 805 that may be coupled to memory 810. Memory 810 may include volatile memory. Processor 805 may execute computer-executable program code stored in memory 810, such as software programs 815. Software programs 815 may include one or more of the logical steps disclosed herein as a programmatic instruction, which may be executed by processor 805. Memory 810 may also include data repository 820, which may be nonvolatile memory for data persistence. Processor 805 and memory 810 may be coupled by bus 830. Bus 830 may also be coupled to one or more network interface connectors 840, such as wired network interface 842 or wireless network interface 844. Computing device 800 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a first party quantum trusted executed environment (QTEE) and from a first party computer program, a first party initial key;
generating, by the first party QTEE, a first party expanded key using the first party initial key;
receiving, by a second party QTEE and from a second party computer program, a second party initial key;
generating, by the second party QTEE, a second party expanded key using the second party initial key;
controlling, by an untrusted third party computer program executed by a server, an untrusted quantum source to distribute an input quantum system to the first party QTEE and to the second party QTEE;
encoding, by the first party QTEE, the input quantum system into a first encoded quantum system using the first party expanded key;
sending, by the first party QTEE, the first encoded quantum system to the untrusted third party computer program;
encoding, by the second party QTEE, the input quantum system into a second encoded quantum system using the second party expanded key;
sending, by the second party QTEE, the second encoded quantum system to the untrusted third party computer program;
performing, by the untrusted third party computer program and using an untrusted quantum measurement device, an entangling measurement on the first encoded quantum system and the second encoded quantum system, resulting an entangling measurement outcome;
sending, by the untrusted third party, the entangling measurement outcome to the first party computer program and the second party computer program, wherein the first party computer program is configured to generate a first party secret key using the first party expanded key and the entangling measurement outcome and the second party computer program is configured to generate a second party secret key using the second party expanded key and the entangling measurement outcome.

2. The method of claim 1, further comprising:
sharing, by the first party computer program, a first pseudo-random number generator algorithm with the first QTEE, wherein the first party QTEE generates the first party expanded key using the first party initial key as a seed to the first pseudo-random number generator algorithm; and
sharing, by the second party computer program, a second pseudo-random number generator algorithm with the second party QTEE, wherein the second party QTEE generates the second party expanded key using the second party initial key as a seed to the second pseudo-random number generator algorithm.

3. The method of claim 1, wherein the entangling measurement comprises a Bell state measurement.

4. The method of claim 1, wherein the untrusted quantum source distributes a first quantum system to the first party QTEE, and a second quantum system to the second party QTEE, wherein the first quantum system and the second quantum system are not the same.

5. The method of claim 1, further comprising:
communicating, by the first party computer program, using the first party secret key; and
communicating, by the second party computer program, using the second party secret key.

6. A system, comprising:
a first party electronic device executing a first party computer program;
a second party electronic device executing a second party computer program;
a server executing an untrusted third party computer program, and comprising:
a first party quantum trusted execution environment (QTEE);
a second party QTEE;
an untrusted quantum source; and
an untrusted quantum measurement device;
wherein:
the first party computer program communicates or transmits a first party initial key with the first party QTEE;
the first party QTEE generates a first party expanded key using the first party initial key;
the second party electronic device communicates or transmits a second party initial key with a second party QTEE;
the second party QTEE generates a second party expanded key using the second party initial key;
the untrusted third party computer program controls the untrusted quantum source to distribute an input quantum system to the first party QTEE and to the second party QTEE;
the first party QTEE encodes the input quantum system into a first encoded quantum system using the first party expanded key;
the first party QTEE sends the first encoded quantum system to the untrusted third party computer program;
the second party QTEE encodes the input quantum system into a second encoded quantum system using the second party expanded key;
the second party QTEE sends the second encoded quantum system to the untrusted third party computer program;
the untrusted third party computer program performs, using the untrusted quantum measurement device, an entangling measurement on the first encoded quantum system and the second encoded quantum system, resulting an entangling measurement outcome;
the untrusted third party sends the entangling measurement outcome to the first party electronic device and the second party electronic device;
the first party electronic device generates a first party secret key using the first party expanded key and the entangling measurement outcome; and
the second party electronic device generates a second party secret key using the second party expanded key and the entangling measurement outcome.

7. The system of claim 6, wherein:
the first party electronic device communicates or transmits a first pseudo-random number generator algorithm with the first QTEE, and the first party QTEE generates the first party expanded key using the first party initial key as a seed to the first pseudo-random number generator algorithm; and
the second party electronic device share a second pseudo-random number generator algorithm with the second party QTEE, and the second party QTEE generates the second party expanded key using the second party initial key as a seed to the second pseudo-random number generator algorithm.

8. The system of claim 6, wherein the entangling measurement comprises a Bell state measurement.

9. The system of claim 6, wherein the untrusted quantum source distributes a first quantum system to the first party QTEE, and a second quantum system to the second party QTEE, wherein the first quantum system and the second quantum system are not the same.

10. The system of claim 6, wherein the untrusted quantum source comprises a laser, a single-photon source, an entangled-photon source, or light-emitting diodes (LEDs).

11. The system of claim 6, wherein the first QTEE and/or the second QTEE comprise an input/output port, a Faraday mirror, a quantum encoder, an attenuator, an optical power limiter, and a filter.

12. The system of claim 6, wherein the first QTEE and/or the second QTEE comprise an input/output port, a Faraday mirror, a quantum encoder, an attenuator, a biased beam splitter, a monitoring detector, and a filter.

13. The system of claim 6, wherein the first QTEE and/or the second QTEE comprise an input port, a first optical power limiter, a first attenuator, a quantum encoder, a second attenuator, a second optical power limiter, a filter, and an output port.

14. A method, comprising:
communicating or transmitting, by a second party computer program, an initial key with a trusted server;
generating, by the trusted server, an expanded key using the initial key;
encoding, by the trusted server, quantum states from a trusted quantum source into an encoded quantum system using the expanded key;
sending, by the trusted server, the encoded quantum system to a first party computer program;
performing, by the first party computer program and using a quantum device, a quantum measurement on the encoded quantum system; and
performing, by the first party computer program and the second party computer program, classical post-processing over an authenticated classical channel using the quantum measurement.

15. The method of claim 14, wherein the expanded key is generated using a pseudo-random number generator with the initial key as a seed.

16. The method of claim 14, wherein the quantum systems are determined by the expanded key.

17. The method of claim 14, wherein the quantum measurement is performed using a quantum measurement from the BB84 protocol.

18. The method of claim 14, wherein the quantum measurement comprises a bit-string that is weakly correlated to the expanded key.

19. The method of claim 14, wherein the classical post-processing converts the outcome of the quantum measurement and the expanded key into a pair of secret keys.

20. The method of claim 19, wherein the pair of secret keys are identical.
